(19) United States
(12) Patent Application Publication
(10) Pub. No.: US 2005/0270366 A1
(43) Pub. Date: Dec. 8, 2005

(54) Three-dimensional image display device

(76) Inventors: Rieko Fukushima, Tokyo (JP); Hitoshi Kobayashi, Kanagawa-Ken (JP); Yuzo Hirayama, Kanagawa-Ken (JP); Kazuki Taira, Tokyo (JP); Tatsuo Saishu, Tokyo (JP); Yasunobu Yamauchi, Kanagawa-Ken (JP); Masahiro Sekine, Kanagawa-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/068,763

(22) Filed: Mar. 2, 2005

(30) Foreign Application Priority Data
Mar. 3, 2004 (JP) 2004-58894

(51) Int. Cl. H04N 13/00

(52) U.S. Cl. 348/42; 348/51

(57) ABSTRACT

The present invention makes it possible to rapidly obtain a two-dimensional image which is not discontinuous and does not include distortion from three-dimensional image display data. When a two-dimensional image is displayed, a viewing point within a viewing zone is assumed, and a parallax image displayed on pixels positioned at a position where a line connecting the viewing point and an exit pupil, and the display unit cross each other or positioned in the vicinity thereof in a state that a three-dimensional image is displayed is developed and displayed within a corresponding elemental image including the pixels.

### CROSS-REFERENCE TO RELATED APPLICATION

This application is based upon and claims the benefit of priority from prior Japanese Patent Application No. 2004-58894 filed on Mar. 3, 2004 in Japan, the entire contents of which are incorporated herein by reference.

### BACKGROUND OF THE INVENTION

1. Field of the Invention

The present invention relates to a three-dimensional image display device.

2. Related Art

A three-dimensional image display techniques can be classified variously. In general, the techniques are classified-to a binocular parallax system using binocular parallax and a space image reproducing system for forming a spatial image actually.

The binocular parallax system includes a binocular system and a multiview system. The binocular is a system that an image for the left eye and an image for the right eye (parallax image) obtained by shooting an object from two shooting positions corresponding to the left eye and the right eye in a perspective projecting manner can be viewed with the left eye and the right eye. The multiview system is a system where the number of video shooting positions is further increased, as compared with the binocular system.

As the space image reproducing system, there are a holography and an integral imaging system (hereinafter, called “II system”). Incidentally, the II system may be classified to the binocular parallax system. However, since a route of a light beam at a shooting time follows a route completely reversed to that at a reproducing time, when the number of light beams is increased sufficiently and image size can be reduced sufficiently, a complete three-dimensional image can be reproduced. For this reason, an ideal II system can be a technique to be classified in the space image reproducing system.

Now, when a three-dimensional image is displayed without using glasses such as the multiview system or the II system, for example, the following constitution can be adopted. That is, a plurality of pixels for two-dimensional image display arranged on a display plane on a two-dimensional image display unit are classified to pixel groups for displaying an elemental image, and an optical plate is arranged on a front face side of the two-dimensional image display unit. Incidentally, exit pupils are provided in the optical plate and designed such that only image information elements of pixels for a two-dimensional image display on which image data corresponding to a viewing position has been displayed can be taken out of pixel groups constituting an elemental image. That is, pixel groups constituting elemental images are partially blocked by the optical plate and pixels for two-dimensional image display which a viewer views via exit pupils are changed for each viewing point, so that the viewer can view a three-dimensional image without using glasses.

In the test or specification of the present application, a camera position or a position of a sight point position when a viewer views a three-dimensional image with his/her one eye in a state that a three-dimensional image has been displayed is expressed as a viewing point, and the pixel indicates a constituent unit displaying image data which is constituent elements for a parallax image and is illustrated as a sub-pixel.

The elemental image will be further explained. The elemental image corresponds to a pin hole camera image shot in a constitution where an exit pupil is replaced by a pin hole. Incidentally, an electronic device is lower in resolution than a silver halide film for the pin hole camera under present circumstances, and the elemental image handled here is only a collection of pixels for displaying a plurality of two-dimensional images obtained at different shooting angles. Therefore, with the above-described constitution, of a collection of pixels for displaying image data constituting an constituent element of an elemental image displayed on image groups constituting individual elemental images, namely, a two-dimensional image (a parallax image) shot from different angles, only image data displayed on pixels coincident with a viewing point or approximately coincident with the same, namely, only image data viewable when a three-dimensional image is actually present are viewed via exit pupils. The definition “approximately coincident with” is based upon such a fact that a range where a single pixel can be viewed via an exit pupil has a certain spreading because a pixel size is not infinitely small. Therefore, except for a case of viewing the center of a pixel viewed from a viewing point via an exit pupil, there is an error between image data displayed on pixels viewed and image data to be originally viewed from a viewing position.

A different between the multiview system and the II system is caused by a low level in resolution in an electronic device. It is ideal that shooting angles for an elemental image are continuous, but the shooting angles must be made discrete due to lack in resolution in an electronic device. In that case, the multiview system takes such a constitution that lines connecting exit pupils and pixels, namely, light beams emitted via exit pupils are non-parallel as regard adjacent exit pupils because a converging point of light beams is provided at a viewing distance, while the II system has such a constitution that the converging point of light beams is not provided at the viewing distance. As a representative example where the converging point of light beams is not provided at the viewing point, there is a case that a parallel relationship is maintained between adjacent exit pupils.

In the multiview system which is often compared with the II system, a perspective projection image acquired from the converging point of light beams can be used in view of a design for the system. Specifically, such a design is employed that a pitch of exit pupils is smaller than a pitch of elemental images, namely, the pitch of exit pupils is narrower than a multiple times (n times) a pitch of pixels. As a result, lines connecting the centers of pixels constituting an elemental image and exit pupils cross at a plurality of positions (n positions) spaced by an inter-eye distance in the viewing distance. With such a constitution, a parallax image can be produced from perspective projection images acquired by a camera disposed at the crossing point, and a viewer can view a stereoscopic image in a state that the right eye or the left eye of the viewer is positioned at the converging point of light beams or in the vicinity thereof.

In the II system where the converging point of light beams is not provided at the viewing distance, there is a parallax image producing method for expanding a viewing zone at a three-dimensional image display time. Specifically, when a certain viewing distance is assumed in the II system, for purpose of maximizing a viewable range at the viewing distance, elemental images formed of (n+1) pixel groups which display image data which is constituent elements for (n+1) parallax images are discretely interposed among elemental images formed of n pixel groups, thereby realizing a relationship where the pitch of exit pupils is smaller than the pitch of elemental images without occurrence of the converging point of light beams at the viewing distance. In other words, discrete interposition of elemental images formed of (n+1) pixels is performed, so that ranges where an elemental image corresponding to all exit pupils can be viewed can be caused to approximately coincide with one another. Incidentally, when all elemental images are constituted of n pixels, lines connecting the centers of the elemental images and the exit pupils become parallel, which means that the viewing distance has been set to infinity. This is equivalent to the multiview system assuming an infinite viewing distance.

Assuming that the number of constituent pixels for an elemental image is n or (n+1), explanation has been made heretofore, but parallax images acquired from n or (n+1) directions are basically used in order to produce these elemental images.

When such setting is made that light beams emitted from adjacent exit pupils have a parallel relationship in the II system where the converging point of light beams is not provided at the viewing distance, it is made possible to use parallel projection images for parallax images to produce a group of elemental images by utilizing the relationship of parallel light beams. In this case, the interposition of elemental images constituting (n+1) pixels means that a parallax image number (an orthographic projection image) from which parallax image data constituting an elemental image is derived is-shifted one by one. That is, in the II system constituted such that an elemental image is produced from orthographic projection images by exactly setting the pitch of exit pupils to n times of pitch of pixels to realize the relationship of parallel light beams, the number of directions in which parallax images acquired are acquired in the orthographic projection system theoretically becomes more than n which is the fundamental number of constituent pixels as far as the viewing distance is not infinite. That is, the II system is more in the number of image acquiring positions (camera positions) than the multiview system where all elemental images can be produced from n perspective projection images.

As a different point between the multiview system and the II system, there is a pixel position which a viewer views via exit pupils. When viewing is performed from the converging point of light beams in the multiview system, a pixel position viewed via all exit pupil becomes a pixel middle. Also, since a pixel width is set to a certain width and a space between converging points of light beams is expanded, a state that a light beam is deviated from the converging point of light beams to the left or right and a light beam does not reach an adjacent converging point of light beams means that a viewer views a position deviated from a middle of a pixel to the left or the right corresponding to his or her position. When a light beam further moves to reach the adjacent converging point of light beams or the vicinity thereof, an image acquired from the next converging point of light beams is viewed from all the exit pupils (since there is a case that light beams converged on each converging point of light beams become ½ all the exit pupils depending on a design, similar behavior can be confirmed about 1/n exit pupils in this case).

On the other hand, in the II system having such a feature that a converging point of light beams is not provided within a viewing zone, when viewing is made from a viewing point at a finite viewing distance, a pixel position viewed via each exit pupil changes cyclically within a screen (a display area on a display). That is, a viewing point for a pixel viewed via each exit pupil is switched from a middle of a pixel to an edge of the pixel, a boundary between the pixel and the next pixel, an edge of the next pixel, and a middle of the next pixel continuously within a screen. Simultaneously therewith, a parallax image number from which image data displayed on pixels is derived is also switched continuously within the screen.

Specifically speaking, when an exit pupil is constituted of a lens and a focal point of the lens is caused to coincide with a display unit, a position viewed via the exit pupil should become infinitely small. However, since an aberration is practically present in the lens, even if an exit pupil is constituted of a pin hole or a slit, a width thereof becomes finite. That is, a numerical aperture of the exit pupil is finite and a region which is viewed via the exit pupil also has a certain width. Therefore, such a fact that a camera number appears via the exit pupil in a switching manner means that a viewer views pixels positioned on both sides of a non-display portion of a pixel on a display unit 4, namely, he/she views two images which are derived from adjacent parallax images simultaneously. As a result, the two images are recognized as an averaged image, so that a portion where switching of parallax image numbers from which image data is derived occurs is prevented from appearing discontinuously.

Next, in the three-dimensional image display device of these systems, a scene which must be switched to a two-dimensional image display by only re-arrangement of three-dimensional image display data will be described. First of all, in a three-dimensional image display device provided in a showroom, it is assumed that a three-dimensional image, for example, a vehicle, is viewed by a plurality of persons within a viewing zone. When it is desired to point out a portion of the three-dimensional image, for example, a headlight, there is a possibility that the pointed-out portion can not be viewed by a person(s) who views a viewing point, for example, a rear portion of the vehicle. In that case, it is expected that three-dimensional image display data is produced for exhibition. In such a case, when switching to a two-dimensional image can be achieved by only re-arranging three-dimensional image display data, and the two-dimensional image can be pointed out, a plurality of persons can be caused to recognize the same portion easily.

Further, in an environment that all contents of a television program or the like are handled as three-dimensional image data, there may be a case that a viewer desires to view an image as a two-dimensional image even when he/she has a display unit for a three-dimensional image display according to his/her feeling, or a case that a two-dimensional image must be outputted from three-dimensional image data distributed to a home in the home having only an output device for a two-dimensional image.

In addition, it is anticipated that such a case occurs that a state of a three-dimensional image viewed from one direction is printed or saved as a two-dimensional image in a file in a design or a utilizing scene of CAD.

As explained above, it can be anticipated easily that there is such a scene that switching to a two-dimensional image display is desired even regarding three-dimensional image data. As a method for realizing this switching, there is already a known technique in the multiview system. That is, regarding all elemental images to be constituted at a three-dimensional image display time using n parallax images acquired in a perspective projection manner, when only image data which is derived from one parallax image of the n parallax images is developed and displayed within a elemental image, only the same image data can be viewed from all viewing positions. That is, switching to a two-dimensional image display where parallax has been lost has been achieved (refer to JP-A-09-102969).

The two-dimensional image which can be displayed through developing and displaying of the single perspective projection parallax image is either one of perspective projection images acquired from converging points of light beams at the viewing distance. Therefore, switching display to a two-dimensional image display from a different viewing point can be conducted by performing switching to a parallax image acquired from a different perspective projection camera to display the same.

On the other hand, in the II system which has not a converging point of light beams in the viewing distance, when a relationship between light beams emitted from, especially, adjacent exit pupils is set to be parallel and an orthographic projection image can be used for a parallax image, since a single parallax image is, of course, an image acquired by orthogonal projection, it is different from an image viewed from finite viewing distance. Further, when a parallax image acquired by orthogonal projection process is used, a parallax image number constituting an elemental image is different for each elemental image, as described in explanation about the difference between the II system and the multiview system. Inversely speaking, an orthogonal projection parallax image which provides image data to all elemental images is limited. When a viewing zone is set to be equal to or more than a screen width, a parallax image where image data corresponding to a screen region remains and which is derived from a single orthogonal projection camera is present in a state that the image data has been processed to image data for a three-dimensional image display. However, regarding many orthogonal projection parallax images, image data about the whole screen is not saved. That is, in a method for displaying a two-dimensional image by developing and displaying a single orthogonal projection parallax image within the whole elemental image, a two-dimensional image at a different viewing point can be hardly displayed.

As described above, a pixel position viewable via an exit pupil changes cyclically in a state that a three-dimensional image has been displayed, so that, even if parallax images which are derived from a plurality of orthogonal projection cameras are switched from one to another for each region when a viewer views the three-dimensional image, the three-dimensional image appears as a continuous three-dimensional image without forming discontinuity at a boundary between regions. Therefore, for performing switching to two-dimensional image display, when developing and displaying are simply performed within each elemental image while a parallax image number is switched from one to another for each display region on a screen, the two-dimensional image becomes discontinuous at a boundary between elemental images where a parallax number has been switched to one to another.

In the II system, there is such a problem that, when switching display to a two-dimensional image is performed by developing and displaying a portion of data for a three-dimensional image display, a distortion is included in the two-dimensional image as compared with a two-dimensional image which is obtained using a single orthogonal projection camera and is viewed from a finite distance and a whole screen display can not be obtained in some cases. Further, even if the two-dimensional image could have been displayed on the whole screen, when a two-dimensional image whose viewing angle has been changed is tried to be displayed, an orthogonal projection image where parallax information allowing a whole screen display remains in the data for a three-dimensional image display is subjected to restriction and a viewing angle which can be switched to its two-dimensional image is limited. When it is attempted to display a perspective projection two-dimensional image by simply adding a plurality of orthogonal projection parallax images with one another, the two-dimensional image becomes discontinuous at a a parallax image number switching portion.

Even in the multiview system, when it is attempted to display a two-dimensional image viewed from a position deviated from a viewing distance in a narrow sense, the two-dimensional image can not be realized with a perspective projection image acquired by a single camera, and it is necessary to add an image obtained by another camera in order to realize the two-dimensional image. Even in this case, there occurs such a problem that the two-dimensional image becomes discontinuous at a portion where switching of a parallax number occurs.

### SUMMARY OF THE INVENTION

The present invention has been made in view of these circumstances, and an object thereof is to provide a three-dimensional image display device which can obtain a two-dimensional image which is not discontinuous as much as possible and does not include distortion from three-dimensional image data.

A three-dimensional image display device according to an aspect of the invention includes: a display unit obtained by arranging pixels constituting a pixel group displaying an elemental image in a matrix array; and an optical plate including exit pupils associated with the pixel group, the elemental image being constituted from a collection of image data which is constituent elements for parallax images acquired from a plurality of directions and regions where the parallax images acquired from the plurality of directions can be viewed being approximately separated from one another spatially to display a three-dimensional image, wherein when switching display to a two-dimensional image is performed using the image data elements for displaying a three-dimensional image, a viewing point within a viewing zone is set, and image data which is constituent elements for a parallax image displayed on pixels positioned at a position where a line connecting the viewing point and an exit pupil, and the display unit cross each other or positioned in the vicinity thereof in a state that a three-dimensional image is displayed is developed and displayed within a corresponding elemental image including the pixels.

The image data which is constituent elements for a parallax image displayed on pixels positioned at a position where a line connecting the viewing point for a three-dimensional image display and the exit pupil, and the display unit cross each other or positioned in the vicinity thereof in a state that an image for displaying a three-dimensional image is displayed can be developed within the corresponding elemental image, while maintaining a ratio where the image data which is the constituent elements for each parallax image spatially occupies the position or the vicinity of the position, so that switching to a two-dimensional image is performed.

the image data which is constituent elements for a parallax image displayed in a range equal to a horizontal direction pitch or a vertical direction pitch for arranging image data which are constituent elements for a different parallax image can be developed within the corresponding elemental image about the position where a line connecting the viewing point and the exit pupil, and the display unit cross each other in a state that an image for displaying a three-dimensional image is displayed, while maintaining a ratio where the image data which is the constituent elements for each parallax image spatially occupies the range, so that switching to a two-dimensional image can be performed.

The image data which is constituent elements for a parallax image displayed in a range equal to two times a horizontal direction pitch or a vertical direction pitch for arranging image data which are constituent elements for a different parallax image can be developed within the corresponding elemental image about the position where a line connecting the viewing point and the exit pupil, and the display unit cross each other in a state that an image for displaying a three-dimensional image is displayed, while maintaining a ratio where the image data which is the constituent elements for each parallax image spatially occupies the range, so that switching to a two-dimensional image can be performed.

When the ratio where the image data which is the constituent elements for each parallax image spatially occupies the position or the vicinity of the position, a range about the position where a line connecting the viewing point and the exit pupil, and the display unit cross each other can be made variable, and a size of the range can be changed according to external input.

When the ratio where the image data which is the constituent elements for each parallax image spatially occupies the position or the vicinity of the position, a range about the position where a line connecting the viewing point and the exit pupil, and the display unit cross each other can be made variable, and a mechanism configured to change the range automatically according to magnitude of a displacement amount of an image between the elemental images can be provided.

When development is performed within the corresponding elemental image so as to maintain the ratio where the image data which is the constituent elements for each parallax image spatially occupies the position or the vicinity of the position, time-wise mixing can be performed.

### BRIED DIESCRIPTION OF THE DRAWINGS

FIG. 1 is a diagram showing a relationship between a parallax image number and a viewing point when development is performed at a two-dimensional image display time according to an embodiment of the present invention;

FIG. 2 is a sectional view showing a structure of a three-dimensional image display device;

FIGS. 3(a) and 3(b) are diagrams showing a parallax image acquirement concept in an II system;

FIGS. 4(a) to 4(f) are diagrams showing the parallax image acquirement concept in the II system;

FIGS. 5(a) and 5(b) are concept diagrams of a parallax image numbers viewed from a central position in the II system;

FIGS. 6(a) and 6(b) are concept diagrams of the parallax image numbers viewed from a position of the viewing distance deviated from the central position to the left side in the II system;

FIG. 7 is an imagined diagram (a viewing range=infinitesimal) of parallax image numbers viewed via exit pupils;

FIGS. 8(a) and 8(b) are diagrams showing an occupation ration of a parallax image to a horizontal direction on a screen when the parallax image number has a developed region on a screen plane;

FIG. 9 is an imagined diagram (a viewing range=pixel width) of parallax image numbers viewed via exit pupils;

FIGS. 10(a) and 10(b) are diagrams showing a first continuously switching concept of parallax image numbers;

FIG. 11 is an imagined diagram (a viewing range=pixel width) of parallax image numbers viewed via exit pupils;

FIG. 12 is a diagram showing a second continuously switching concept of parallax image numbers;

FIGS. 13(a) and 13(b) are diagrams for explaining switching in an area gradation manner for each elemental image;

FIGS. 14(a) and 14(b) are diagrams for explaining switching in an area gradation manner for each elemental image;

FIGS. 15(a), 15(b), and 15(c) are diagrams for explaining switching in an area gradation manner for each pixel image;

FIGS. 16(a) and 16(b) are diagrams for explaining a time-divisional display;

FIGS. 17(a) and 17(b) are diagrams for explaining a time-divisional display;

FIGS. 18(a) and 18(b) are concept diagrams showing parallax image numbers viewed from a position in a distance shorter than a viewing distance in a multiview system;

FIGS. 19(a) and 19(b) are concept diagrams showing parallax image numbers viewed from a position in a distance longer than the viewing distance in the multiview system;

FIG. 20 is a block diagram showing a driving circuit in a three-dimensional image display device according to an embodiment of the present invention;

FIG. 21 is a graph showing a relationship between a range where a parallax image developed within an elemental image is obtained and a signal voltage difference at a parallax number switching portion of an image to be displayed;

FIG. 22 is a diagram showing a time-divisional display;

FIG. 23 is a timing chart I of the time-divisional display;

FIG. 24 is a timing chart II of the time-divisional display; and

FIG. 25 is a table showing values of respective parameters used in Example 1 of the present invention.

### DETAILED DESCRIPTION OF THE INVENTION

Embodiments of the present invention will be explained below with reference to the drawings.

### First Embodiment

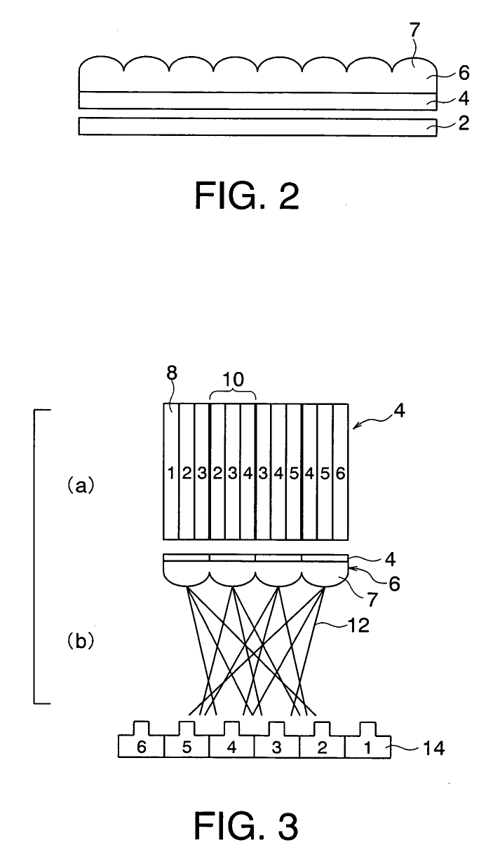

A three-dimensional image display device according to a first embodiment of the present invention is a three-dimensional image display device which can perform switching to a two-dimensional image at an arbitrary viewpoint using a three-dimensional image display data in an II system or a multiview system. The three-dimensional image display device according to the embodiment is shown in FIG. 2. FIG. 2 is a view of the three-dimensional image display device according to the embodiment viewed from a vertical direction, or a sectional view thereof taken along a horizontal direction. The three-dimensional image display device according to the present invention is provided with a light source 2 which emit light beams as a back light, an image display unit 4, and an optical plate 6. The image display unit 4 is constituted of, for example, a liquid crystal display device, and it is provided with a display plane formed by arranging a plurality of pixels in a matrix manner, and a driving circuit (not shown) which transmits image signals to the plurality of pixels constituting the display face to drive the pixels. Incidentally, when the image display unit 4 is of a transmission type such as a liquid crystal display device, the light source 2 serving as the back light is required, but the light source 2 is not required when the image display unit 4 is of a self-emitting type. The optical plate 6 is provided with opening control portions 7 which restricts light beams from the image display unit 4 to control directions of light beams. In FIG. 2, the optical plate 6 is a lenticular sheet having exit pupils 7 constituted of cylindrical lenses, but it may be a slit array plate having exit pupils constituted of slits, for example.

First of all, a parallax image which is developed within each elemental image in order to perform switching to a two-dimensional image display will be explained. Specifically, a viewing point for an arbitrary two-dimensional image re-construction is provided within a viewing zone at a three-dimensional image display time, and image data which is constituent elements for a parallax image displayed on a crossing point between a line connecting the viewing point and each exit pupil and a pixel plane for a two-dimensional image display on the image display unit is developed and displayed within an elemental image to which the image data which is the constituent elements for the parallax image belongs. Thereby, display on the three-dimensional image display device can be switched to a two-dimensional image viewed from the viewing point with one eye of a viewer. The two-dimensional image does not change even if it is viewed at any place. Especially, when switching display to a two-dimensional image viewed at a viewing point on the viewing distance even within the viewing zone is performed, an operation for selecting image data elements whose relative positions are approximately coincident with one another within the elemental image from image data elements which are derived from a plurality of parallax images constituting each elemental image and developing the selected image data elements within each elemental image is performed. This operation will be explained below.

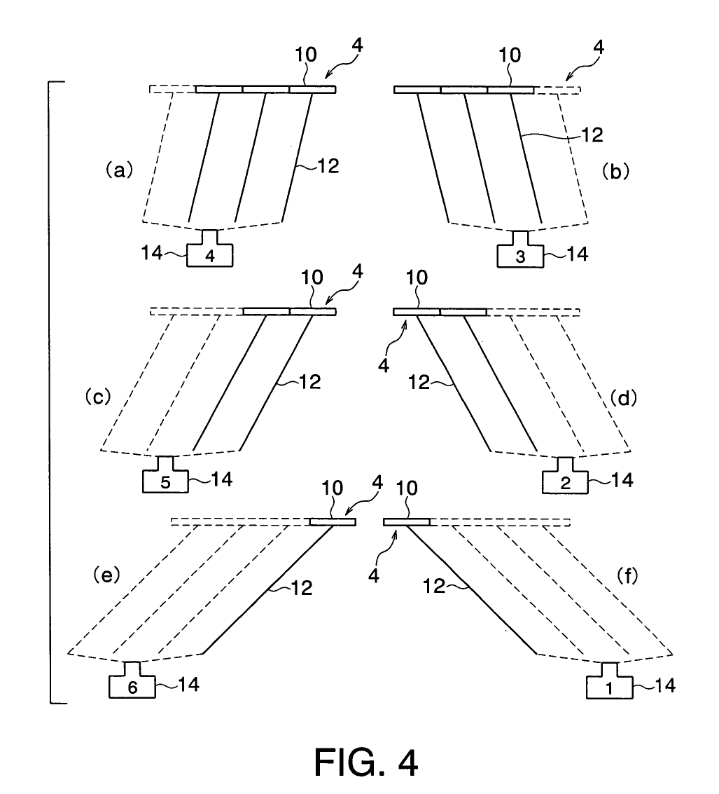

For simplification of explanation, image data elements partially extracted from a parallax image for constituting an elemental image, namely, image data elements which are constituent elements for the parallax image is simply called “a parallax image”. Further, a case that the three-dimensional image display device employs a one-dimensional II system having parallax information only in a horizontal direction, exit pupils are formed in a shape obtained by vertically continuous exit pupils (for example, cylindrical lenses), and a parallax image is formed in a rectangular shape displayed with vertically continuous pixel groups corresponding thereto will be explained with reference to FIG. 3(a) to FIG. 4(f). Moreover, a pitch of exit pupils is set to integral multiple of a pixel such that an orthographic projection image is used as the parallax image.

FIG. 3(a) is a diagram showing a display plane of the image display unit 4 constituted of four elemental images 10 each constituted of three parallax images 8, and FIG. 3(b) is a horizontal sectional diagram showing a three-dimensional display device showing a relationship between image acquiring positions 14 and exit pupils 7. In FIG. 3(a), a numeral assigned to each parallax image 8 denotes a parallax image number. For example, the leftmost elemental image 10 on a display screen of the display unit 4 has parallax images 8 assigned with parallax image numbers 1, 2, and 3 from the left side, the second elemental image 10 from the left side has parallax images 8 assigned with parallax image numbers 2, 3, and 4, the third elemental image 10 from the left side has parallax images 8 assigned with parallax image numbers 3, 4, and 5, and the fourth elemental image 10 from the left side has parallax images 8 assigned with parallax image numbers 4, 5, and 6.

In FIG. 3(b), reference numeral 12 denotes a light beam connecting a parallax image center and an exit pupil 7, which also indicates a direction from which a corresponding parallax image is acquired. A parallel relationship occurs between light beams passing through adjacent exit pupils, which means that an elemental image can be produced from an orthogonal projection image. A number assigned to the image acquiring position corresponds to an orthogonal projection parallax image number, namely, corresponds to a camera number which has acquired an orthogonal projection image of the orthogonal projection parallax image number. An image acquiring position corresponding to a parallax image number 4 is shown in FIG. 4(a), an image acquiring position corresponding to a parallax image number 3 is shown in FIG. 4(b), an image acquiring position corresponding to a parallax image number 5 is shown in FIG. 4(c), an image acquiring position corresponding to a parallax image number 2 is shown in FIG. 4(d), an image acquiring position corresponding to a parallax image number 6 is shown in FIG. 4(e), and an image acquiring position corresponding to a parallax image number 1 is shown in FIG. 4(f). As understood from FIG. 4(a), for example, the first, second, and third elemental images 10 on the display unit 4 from the right side are constituted using a parallax image attached with an orthogonal projection parallax image number 4.

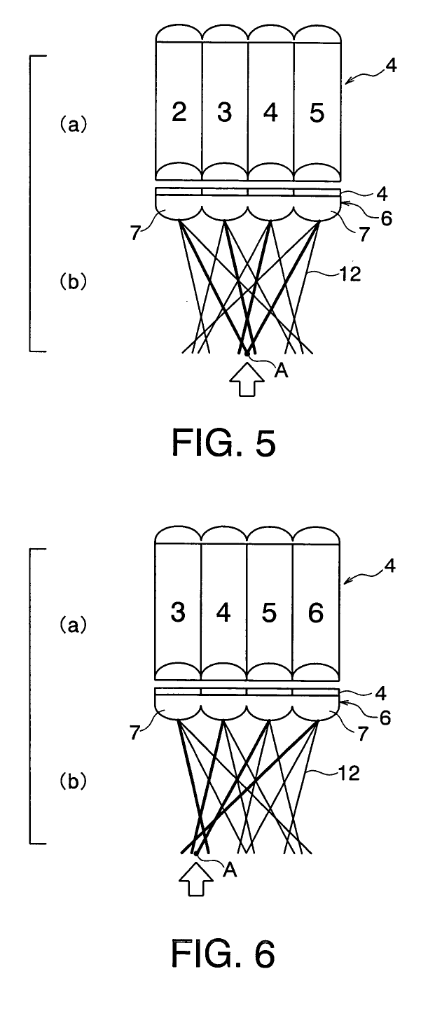

With such a constitution, parallax images viewed via exit pupils depending on a viewing point are shown in FIGS. 5(a) to 6(b). FIGS. 5(a) and 5(b) show a case that a viewing point A indicated by arrow is positioned at the center of a viewing distance plane, FIG. 5(a) being a view showing main parallax image numbers viewed via exit pupils 7, and FIG. 5(b) being a horizontal sectional view of the three-dimensional image display device showing a relationship between an accurate image acquiring direction of parallax images viewed from the viewing point A via the exit pupils 7 and the viewing position. As shown in FIGS. 5(a) and 5(b), when the viewing point A is positioned at the center on the viewing distance plane, a parallax image positioned at the center of each elemental image 10 is mainly selected and viewed. That is, a parallax image 8 having a parallax image number of 2 positioned at the center of the leftmost elemental image 10 on the display screen of the display unit 4 shown in FIG. 3(a) is selected from the leftmost elemental image 10, a parallax image 8 having a parallax image number of 3 positioned at the center of the second elemental image 10 from the left side is selected from the second elemental image 10, a parallax image 8 having a parallax image number of 4 positioned at the center of the third elemental image 10 from the left side is selected from the third elemental image 10, and a parallax image 8 having a parallax image number of 5 positioned at the center of the fourth elemental image 10 from the left side is selected from the fourth elemental image 10 (refer to FIG. 5(a)). Here, the expression “mainly” means that, since a deviation between the image acquiring direction and the viewing direction occurs in the II system where light beams are not converged at the viewing distance, as shown in FIG. 5(b), an image mixed with an adjacent parallax image corresponding to the deviation from a single exit pupil is viewed depending on an opening width of the exit pupil.

FIGS. 6(a) and 6(b) shows a case that the viewing point A indicated by arrow is deviated from the center on the viewing distance plane to the left side, FIG. 6(a) being a view showing main parallax image numbers viewed via exit pupils 7 and FIG. 6(b) being a horizontal sectional view of the three-dimensional image display device showing a relationship between an accurate image acquiring direction of main parallax images viewed from the viewing point A via the exit pupils 7 and the viewing position. As shown in FIGS. 6(a) and 6(b), when the viewing point A is deviated from the center of the viewing distance plane to the left side, a parallax image positioned at the right side on each elemental image 10 is selected from the elemental image 10 and viewed corresponding to the deviation. That is, a parallax image 8 having a parallax image number of 3 positioned at the right side is selected from the leftmost elemental image 10 on the display screen of the display unit 4 shown in FIG. 3(a), a parallax image 8 having a parallax image number of 4 positioned at the right side is selected from the second elemental image 10 from the left side, a parallax image 8 having a parallax image number of 5 positioned at the right side is selected from the third elemental image 10 from the left side, and a parallax image 8 having a parallax image number of 6 positioned at the right side is selected from the fourth elemental image 10 from the left (refer to FIG. 6(a)). Here, the expression “mainly” is also used considering that, depending on a deviation between the image acquiring direction and the viewing direction such as shown in FIG. 6(b) and an opening width of an exit pupil, an image mixed with a plurality of parallax images from a single exit pupil is viewed due to the deviation.

As understood from the explanation regarding FIG. 5(a) to FIG. 6(b), a relative position of a parallax image viewed from the viewing point A on the viewing distance plane within an elemental image is approximately coincident with a relative position of the viewing point A on the viewing distance plane in a state that a three-dimensional image has been displayed. That is, if it is desired to perform switching display to a two-dimensional image obtained when viewed at the center in a viewing zone on a viewing distance plane, such a two-dimensional image can be obtained by approximately developing a parallax image positioned at the center of each elemental image within the elemental image. On the other hand, when it is desired to perform switching display to a two-dimensional image obtained when viewed at a place where the viewing point A has been deviated from the center of the viewing distance plane to the left side, a parallax image to be developed in an elemental image also changes according to a relative position of the viewing point A.

Here, using the term “approximately” is based upon that a plurality of parallax image numbers are actually viewed from a single exit pupil with reflection of a deviation between the image acquiring direction and the viewing position. Strictly, unless development is performed with such reflection, an image obtained does not coincide with the two-dimensional image viewed at the viewing position. In FIGS. 3(a), 3(b), 5(a), 5(b), 6(a), and 6(b), the elemental image groups are simplified to four. However, in an actual system for a three-dimensional image display device, a plurality of exit pupils where a single parallax image is mainly viewed from a viewing point occur, and an occupying rate of the mainly viewed parallax image gradually changes, so that smooth switching to a parallax image with a different acquiring position occurs due to continuous mixture with an adjacent parallax image and such a switched state must be reflected even at a two-dimensional image display time.

In determination of the viewing distance and the viewing zone, when a horizontal position of a pixel for two-dimensional image display from one edge of a display screen is represented as Xp and a position of an exit pupil corresponding to the pixel is represented as Xs, an orthogonal projection parallax image number N (Xp, Xs) to be displayed with the pixel for two-dimensional image display is defined with the following equation (1).
N(Xp, Xs)=Nall/2−(Xs−Xp)/hp−0.5 (1)

Here, in order to satisfy a relationship of parallel beams, a pitch of exit pupils is set to be integral multiple of a pitch of pixels, and the orthogonal projection parallax image numbers are assigned from one end to one end opposed therefrom. Further, hp represents a pitch of two-dimensional image display pixels, Nall represents all parallax numbers acquired, and the equation (1) is satisfied when the center in the viewing zone is caused to coincide with the center of the screen.

Similarly, in the embodiment, it is also possible to give a relational equation to a parallax image number to be developed and displayed at a time of switching to a two-dimensional image. In the same condition as that in the equation (1), assuming that the viewing point is positioned at the center in the viewing distance, the parallax image number N (Xp, Xs) to be mainly developed within an elemental image at a switching display time of a two-dimensional image in the embodiment is expressed by the following equation (2).
N(Xp, Xs)=Nall/2−{(H/2−Xs)×g/L}/hp−0.5 (2)

Here, g represents a distance between an optical plate and an image display unit, L represents a distance (a viewing distance) between a viewing point and the optical plate, and H represents a screen width of the image display unit.

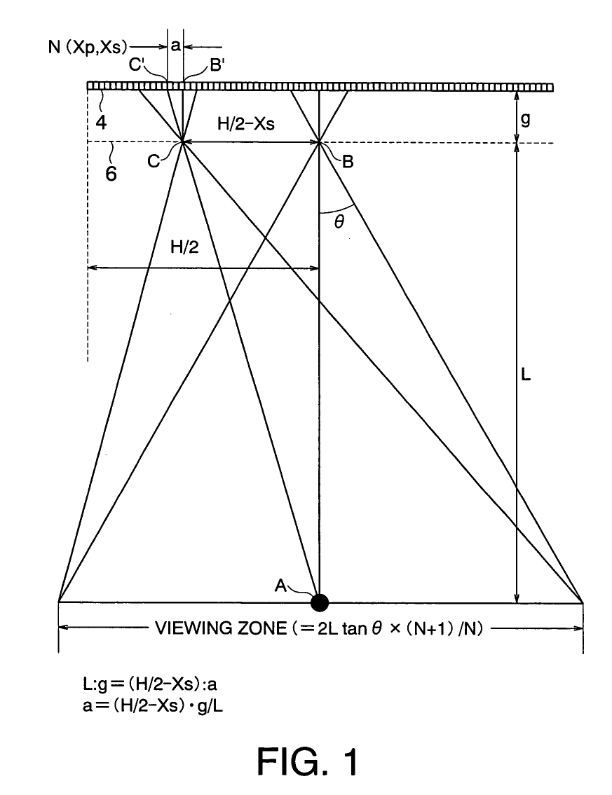

The above equation (2) will be explained with reference to FIG. 1. FIG. 1 is a horizontal sectional view of the three-dimensional image display device, which shows a relationship between a parallax image number developed at a two-dimensional image switching display time in the present embodiment and a viewing point serving as a guideline for a two-dimensional image to be displayed. The viewing point A is positioned at the center in the viewing zone, an exit pupil B is positioned at the center of the display unit 4, and a line connecting the viewing point A and the exit pupil B is orthogonal to the display unit 4. An exit pupil C is an exit pupil whose horizontal position from the left end of the optical plate 6 is Xs. A point B′ is a leg of a line normal to the display unit 4, and a point C′ is a crossing point of a straight line connecting the viewing point A and the exit pupil C and the display unit 4. Incidentally, an angle θ is defined such that, assuming that an exit pupil corresponding to an elemental image constituted of (n+1) parallax images is positioned at the center of the screen, the angle is a viewing zone angle at which the elemental image can be viewed.

Parallax image information positioned between a crossing position B′ of a line connecting the viewing point A and the exit pupil B and the display unit 4 and a crossing point C′ of a line connecting the viewing point A and the exit pupil C and the display unit 4 is developed within an elemental image. A triangle ABC and another triangle CB′C′ are in a similar figures. When the center in the viewing zone and the center on the screen are caused to coincide with each other, acquiring directions for an orthographic projection parallax image are also set such that a normal line to the screen forms a symmetrical line. A parallax image number displayed on a pixel at a position of the point B′ at a time of three-dimensional image display is equal to a central position of the plurality of image acquiring directions, namely, a center value (Nall/2) of all the parallax image numbers (Nall). A distance B′C′ from a pixel at the position of the point B′ to a pixel at a position of the point C′ forming the center of an elemental image is divided by the pitch hp of two-dimensional image display pixels, so that a parallax image number displayed at the center of the elemental image is obtained in the state of the data for three-dimensional image display. The parallax image displayed at the pixels is viewed from the viewing point A in the three-dimensional image display state, and the parallax image is developed in a corresponding elemental image, so that a two-dimensional image recognized when viewed with one eye of a viewer from the viewing point A can be viewed at all regions within the viewing zone.

It is understood that the equation (2) is different from the equation (1) in that the parallax image number N (Xp, Xs) to be displayed is determined based upon only the position Xs of an exit pupil to which a pixel group which is a display region for an elemental image is caused to correspond but it does not depend on the position Xp of the pixel in the equation (2).

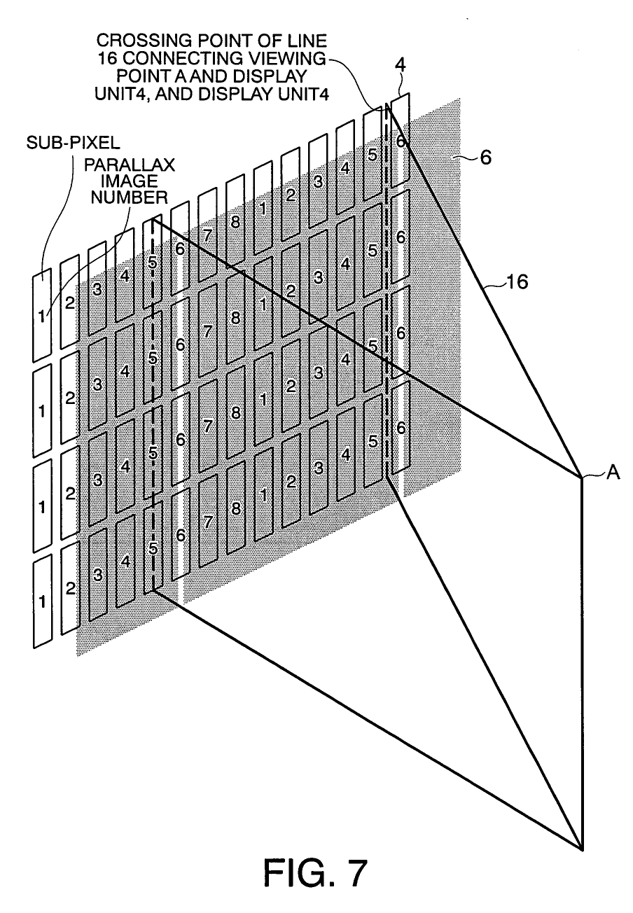

A single parallax image number (=a camera number) shown with the equation (2) corresponds to the case that the region viewed via an exit pupil is infinitely small, as shown in FIG. 7. This corresponds to a case that the optical plate 6 is constituted of a lens and a display plane of a display unit is disposed on a focal plane of the lens. In FIG. 7, reference numeral 16 denotes a line connecting the viewing point A and the exit pupil 7. Repeatedly speaking, since a pixel position appearing via an exit pupil changes cyclically within a screen from any position within a viewing zone in the II system, if such a lens could have been designed, luminance modulation when a pixel portion or a non light-emitting portion at a boundary between pixels is viewed is viewed as moire within a screen with strong contrast and parallax image numbers viewed through respective exit pupils become singular in a state that a three-dimensional image has been displayed, so that an image should become discontinuous at a parallax image number switching portion.

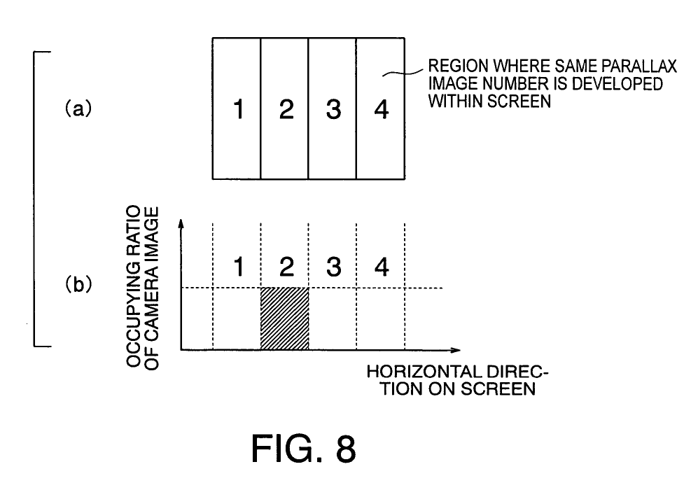

Similarly, when the singular parallax image number obtained by the equation (2) is developed within an elemental image as it is, and two-dimensional image display is performed, an image becomes discontinuous at a portion where parallax image numbers (=camera numbers) become discontinuous like the three-dimensional image display time. Especially, regarding contents with a large depth/projection amount in a three-dimensional image, an image becomes discontinuous at a parallax number switching portion. Such a phenomenon can be understood in the following manner. That is, even if parallax number switching, or image acquiring position switching occurs in contents with a small depth/projection amount, image information does not change largely, namely, parallax is small. However, in the case of the contents with a large depth/projection amount, when parallax number switching occurs, an image changes largely, namely, parallax is large. Therefore, an image becomes discontinuous between adjacent exit pupils having different numbers, i.e., at a seam of adjacent orthographic projection camera images. A concept of distribution of parallax numbers obtained when parallax numbers are switched in a binary manner in this manner is shown in FIGS. 8(a) and 8(b). FIG. 8(a) is a diagram showing a region where parallax image numbers 1 to 4 are developed within a screen on the display unit 4, and FIG. 8(b) is a graph showing an occupying rate of a parallax image number to a horizontal direction of the screen.

In fact, when a slit plate is used as the optical plate 6, an opening must have a finite width. Further, for example, when cylindrical lenses are used as the optical plate 6, a problem due to aberration or the like occurs actually, which means viewing over a finite range via an exit pupil in practice. In order to suppress, to the minimum, fluctuation of a focal length in a vertical direction due to spherical aberration of cylindrical lenses provided uniformly in front of a display screen, such a design may be adopted that a display plane of a display unit is positioned slightly inwardly or outwardly from a focal length of each cylindrical lens (design is made slightly in a defocusing manner). Thereby, an average value of focal point fluctuation (spherical aberration) due to fluctuation of a prospective angle formed by connecting a viewer and respective cylindrical lenses can be caused to approximately coincide with a pixel portion on the display unit 4. By making design slightly in a defocusing manner, parallax image switching can be made smooth and such an advantage can be obtained that contrast of luminance reduction due to a non-display portion can be suppressed.

As described above, in a system where a lenticular sheet is used as the optical plate in an actual II type three-dimensional image display device, there is such a tendency that a numerical aperture of an exit pupil is designed to be equal to or more than a pixel width. Therefore, when switching to a two-dimensional image display is performed using data for three-dimensional image display, a parallax image to be developed in each elemental image can also be selected considering such a defocus, so that switching display to a two-dimensional image more similar to a two-dimensional image viewed with one eye of a viewer at a three-dimensional image display time can be performed.

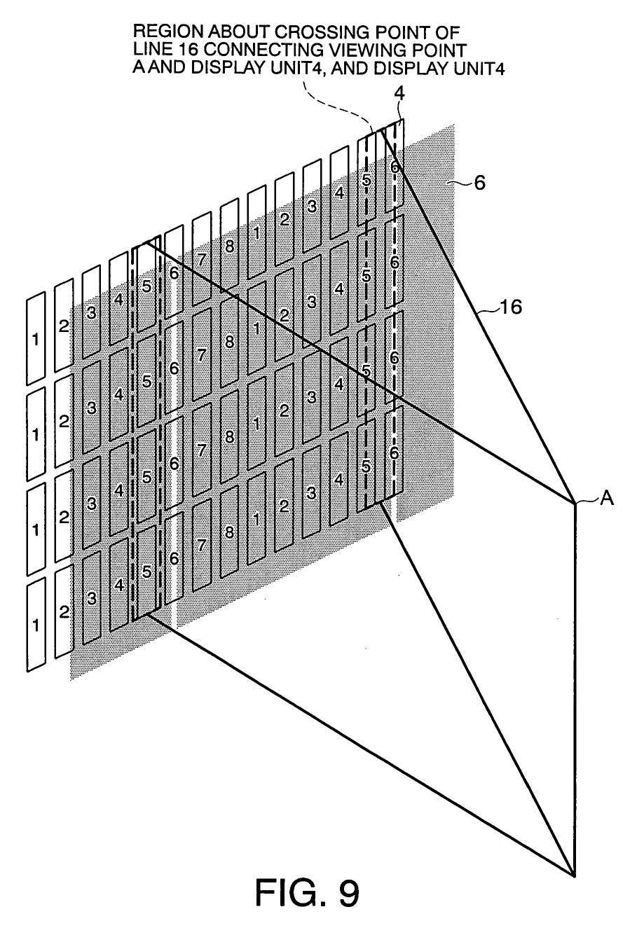

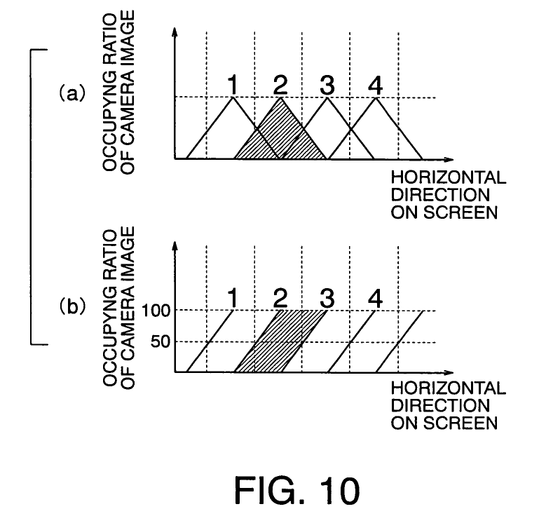

Accordingly, in order to switch a ratio of a parallax image viewed via an exit pupil continuously like the case of view from a viewing point at a three-dimensional image display time, as shown in FIG. 9, it is effective to assume a finite range as a region viewed via an exit pupil to develop a plurality of parallax images within an elemental image at the same ratio as an occupying ratio of the plurality of parallax images to the region. A parallax image corresponding to FIG. 9 showing that a region viewed via an exit pupil is equal to a pixel width is shown in FIGS. 10(a) and 10(b). FIGS. 10(a) and 10(b) are graphs showing, along a horizontal position, a distribution of parallax image numbers viewed via respective exit pupils arranged in a horizontal direction on a screen obtained when a viewer views a displayed three-dimensional image with his/her one eye from a viewing point on a finite distance. FIG. 10(a) is a graph showing a case that adjacent parallax image numbers viewed from exit pupils in a mixed manner are displayed in an overlapping manner, and FIG. 10(b) is a graph showing a case that adjacent parallax imaged numbers viewed in a mixed manner are displayed so as not to overlap with one another. In FIGS. 10(a) and 10(b), for example, the parallax image number 2 shown by hatching shows an occupying ratio of 100% with only an exit pupil which is positioned at the center of the exit pupils positioned in the range where the parallax image number 2 can be viewed in FIG. 8(b), and an occupying ratio linearly decreases before and after the parallax image number 2. According to approaching to a region where an adjacent parallax image number has been developed, for example, the parallax image number 1 has been developed, a ratio of the parallax image number 1 to be viewed rises linearly.

Therefore, when a parallax image number to be developed in an elemental image in order to perform switching to a two-dimensional image display, as shown in FIG. 9, a single parallax image number, namely a camera image number is developed in an elemental image group where a region from which a ratio of a parallax image to be developed is obtained is set to a pixel width and a line connecting the viewing point and the exit pupil center coincide with a pixel center, but a plurality of parallax image numbers are developed within an elemental image corresponding to an exit pupil deviated from a pixel center in a mixed manner. By developing an image along such a guideline, an occupying ratio of both parallax images can be smoothly changed at a boundary portion between parallax image numbers on a screen in a state that a two-dimensional image has been displayed in a switched manner.

Regarding contents with a large projetion/depth amount, however, a single parallax image can be viewed in the vicinity of an exit pupil through which the single parallax image can be viewed, but two different parallax images appear in a mixed manner according to separation from the vicinity of an exit pupil. Therefore, such a problem occurs that a blur amount appears in a fluctuating manner in a horizontal direction such that clearness and blur repeat in an image.

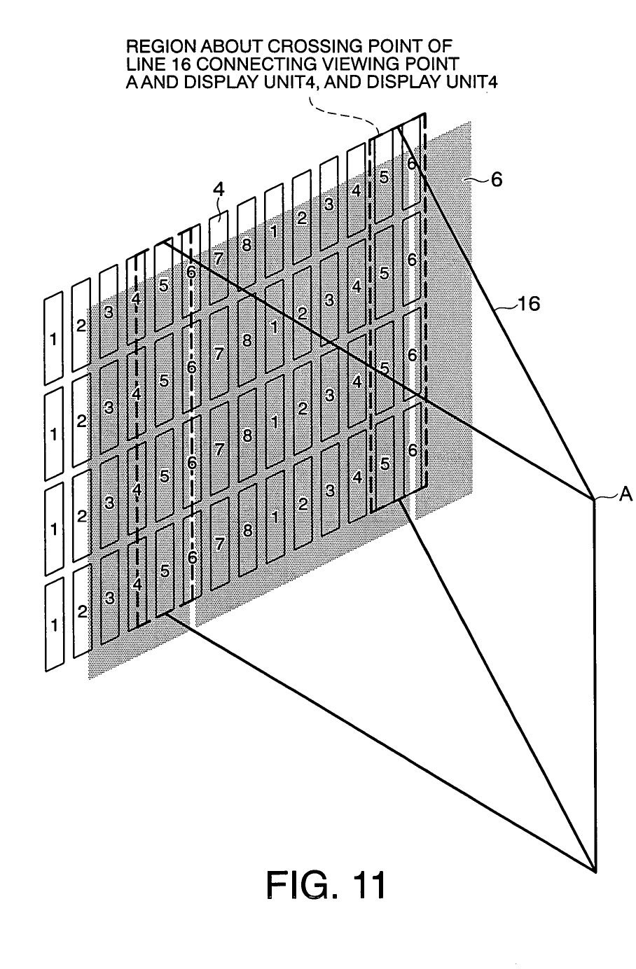

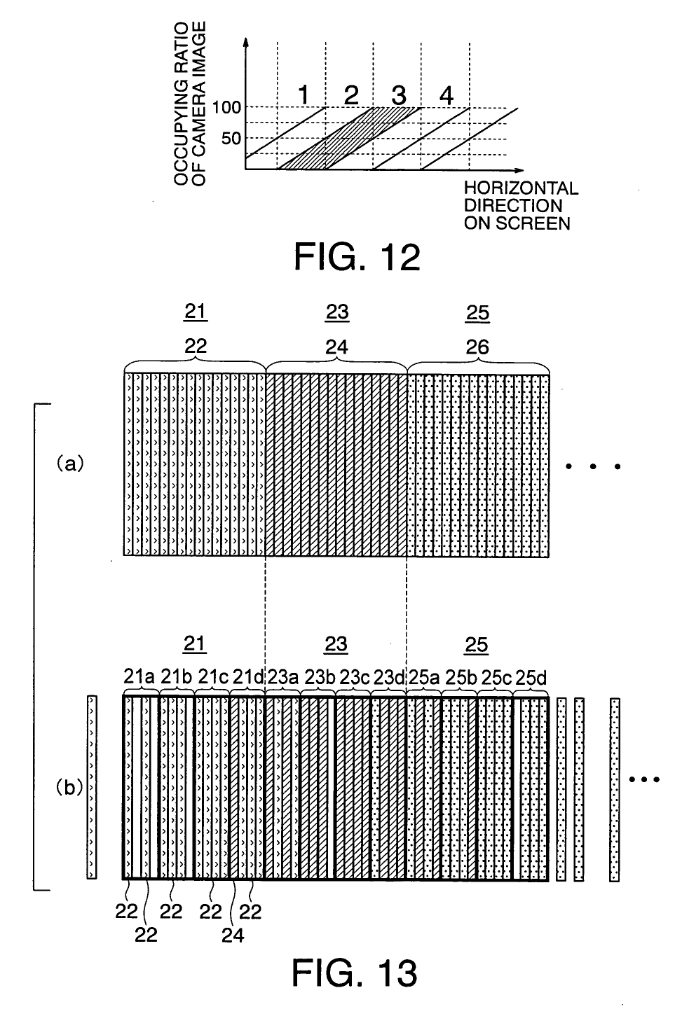

In such a case, therefore, as shown in FIG. 11, it is effective to increase a numerical aperture of an exit pupil for three-dimensional image display or expand a region for obtaining a ratio of a parallax image number to be developed within an elemental image at a switching display time of a two-dimensional image. Here, the occupying ratio has been obtained in a region of two times a pixel width. Here, such a fact that the degree of defocusing of a lens of an optical plate in a three-dimensional image display device is large means shifting of an image to further defocus. A distribution of parallax image numbers appearing on a display plane when a viewer views a three-dimensional image display on a viewing point in a finite viewing distance with his/her one eye, which corresponds to the case shown in FIG. 11 is shown in FIG. 12. FIG. 12 is a graph showing a ratio of parallax images viewed via respective exit pupils in a screen horizontal direction. As shown in FIG. 12, an occupying ratio of a single parallax image information remains in at most 50%. As described previously, however, since contents in the vicinity of the screen is originally small, it is hardly affected by defocusing. On the other hand, regarding contents positioned largely short of the screen or on the depth side thereof, defocus increases, but displacement of a defocus amount in a horizontal direction viewed in FIGS. 9, 10(a) and 10(b) can be suppressed substantially completely. Therefore, by developing a parallax image reflecting the occupying ratio shown in FIG. 12 within an elemental image, displacement of the defocus amount in a horizontal direction can be substantially completely suppressed even in a switching display to a two-dimensional image, and contents positioned largely short of the screen or on the depth side thereof can be displayed in a defocused manner.

In the above, the method for performing switching to two-dimensional image display by obtaining connecting lines, which are connecting a viewing point and exit pupils, and a display plane on a display unit, and parallax images displayed on a surrounding region of the connecting lines and developing and displaying the parallax images within an elemental image reflecting the occupying ratios of the parallax images has been explained. A specific ratio of mixed display can be obtained using the following expression (3) obtained by developing the equation (2).
N(Xp, Xs)=Na11/2−{(H/2−Xs−w)×g/L}/hp−0.5 (3)

For example, an occupying ratio in a region corresponding to a pixel width shown in FIG. 9 can be obtained by obtaining a ratio of a singular or plural N (Xp, Xs) (parallax image number) displayed in a range defined by the following (4) such that w corresponds to a pixel width.
−hp·L/2≦w<hp·L/2 (4)

An occupying ratio in a region corresponding to a two-pixel width shown in FIG. 11 can be obtained by obtaining a ratio of a singular or plural N (Xp, Xs) displayed in a range defined by the following (5) such that w corresponds to a two-pixel width.
−hp·L≦w<hp·L (5)

By performing development along the above line reflecting a ratio of plural parallax images obtained within an elemental image corresponding to an exit pupil (coordinate: Xs), switching display to a two-dimensional image viewed from a single viewing point at a three-dimensional image display time can be performed. That is, parallax image information larger or smaller than a single parallax image number (=a camera number) obtained according to the equation (2) by one or two is developed and displayed within a corresponding elemental image in a mixing manner. That is, by only performing selection from image data used in three-dimensional image data and development, a two-dimensional display can be realized which has a parallax number switching portion where smooth switching occurs between parallax images like the case of using the equation (1).

Now, it is understood that by obtaining parallax image numbers displayed in the corresponding region according to the equations (3), (4), and (5) and performing development within a single elemental image according to an occupying rate of the parallax image number while mixing a plurality of parallax images, a two-dimensional image display with the distribution shown in FIG. 10(a), FIG. 10(b), or FIG. 12 can be realized. Two method for realizing a two-dimensional image display equivalent to the above by only utilizing the result obtained according to the equation (2) and mathematical handling will be explained below.

Repeatedly speaking, elemental images corresponding to respective exit pupils are displayed on a pixel group in a state that a three-dimensional image has been displayed, and each elemental image is constituted of a plurality of parallax images with continuously changing parallax image numbers. An example of a three-dimensional image display device of a one-dimensional II type which provides parallax information only in a horizontal direction will be explained specifically. Each parallax image is displayed on a narrow region whose horizontal direction is defined by one pixel and whose vertical direction is defined by all longitudinal pixels, and an elemental image is constituted of n or (n+1) sub-pixels in a horizontal direction and all longitudinal sub-pixels in a vertical direction by assembling n or (n+1) parallax images. When a relationship of parallel beams is realized, a horizontal width of the elemental image (a sub-pixel horizontal width×n) is coincident with a pitch of exit pupils (in a lenticular sheet, a lens horizontal width, a sub-pixel horizontal width×n).

When switching display to a two-dimensional image is performed, as one method for realizing the distribution shown in FIG. 10(a), 10(b), or 12 within a screen, there is a method for performing a mixing distribution for each pixel constituting a parallax image to be developed within an elemental image display region, but there is a method for performing a mixing distribution for each elemental image display region within a screen as a simpler method therefor.

As a method for realizing the distribution shown in FIG. 10(a), 10(b), or 12 by utilizing the equation (2) and a mathematical handling, first, a method for performing mixing for each elemental image display region within a screen will be explained. In illustrations shown in FIG. 5(a) to FIG. 8(b), cylindrical lenses or elemental images on which parallax image numbers viewed via exit pupils at a three-dimensional image display time and obtained according to the equation (2) or parallax image numbers to be developed when a switching display to a two-dimensional image is performed has been shown as one element in a simplified manner. However, in an actual three-dimensional image display device, a plurality of elemental images on which the same parallax image is developed according to the equation (2) occurs. In FIGS. 13(a) and 13(b), as one example, a case that the number of elemental images on which the same parallax image is developed according to the equation (2) is 16 is illustrated. FIG. 13(a) is a illustrative diagram showing a region 21 where 16 elemental images 22 on which a first parallax image number has been developed are distributed, a region 23 adjacent to the region 21 where 16 elemental images 24 on which a second parallax image number has been developed are distributed, and a region 25 adjacent to the region 23 where 16 elemental images 26 on which a third parallax image number has been developed are distributed.

FIG. 13(b) is an illustrative diagram of a case that these elemental images are mixed for each elemental image display region so as to realize a distribution equivalent to FIGS. 10(a) and 10(b). A method for realizing this distribution will be explained. When the number of elemental images adopting the same parallax image number is represented as X, smooth switching to an adjacent parallax image can be performed by replacement of n elemental images through n steps. That is, continuous parallax image switching can be realized by increasing, one by one, a mixing ratio of an elemental image developed with a parallax image with a parallax image number different by one for each elemental image group constituted of X X elemental images so as to achieve n²=X. In FIG. 13(b), since X is 16, adjacent parallax image replacement can be performed continuously via 16 elemental images by increasing elemental images developed with a parallax image with an adjacent number one by one over 4 (=√ X) for 4=(√ X) groups. For example, a sub-region 21a on the region 21 at the left end thereof is constituted of two elemental images developed with a parallax image 22 and two elemental images developed with a parallax image number displayed on a region (not shown) positioned on the left side of the region 21 shown in FIGS. 13(a) and 13(b), and a second sub-region 21b on the region 21 from the left thereof is constituted of three elemental images developed with the parallax image 22 and one elemental image developed with the parallax image number displayed on the region (not shown) positioned on the left side of the region 21 shown in FIGS. 13(a) and 13(b). A third sub-region 21c on the region 21 from the left thereof is constituted of four elemental images developed with the parallax image 22, and a fourth sub-region 21d on the region 21 from the left thereof is constituted of three elemental images developed with the parallax image 22 and one elemental image developed with a parallax image number 24 developed on a region 23 positioned at the right side of the region 21 shown in FIG. 13(a).

As a result, smooth switching between parallax image numbers can be realized like the case shown in FIGS. 10(a) and 10(b).

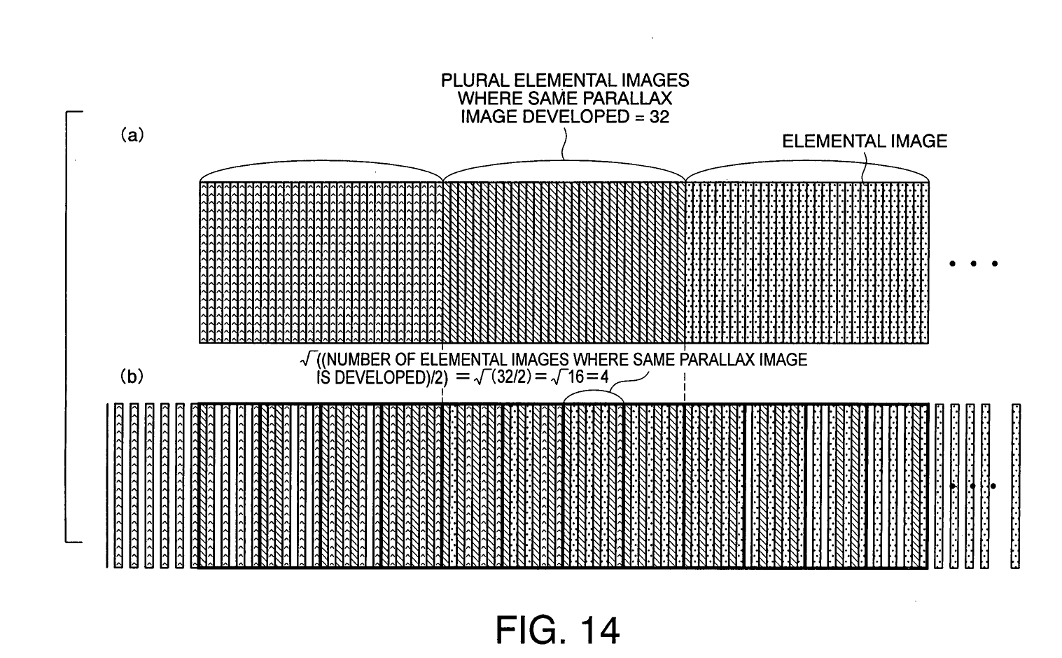

Next, an example where a continuous switching is performed such as shown in FIG. 12 along a similar way of thinking will be explained. When the number of elemental images adopting the same parallax number is set to X (=32), as shown in FIG. 14(b), a continuous parallax image switching can be realized by increasing a mixing ratio of an elemental image selected with an adjacent parallax image for each √ (√/2) elemental images, as shown in FIG. 14(b). In FIG. 14(b), such a slant replacement has been realized that a ratio of corresponding parallax images is increased via 32 elemental images by increasing elemental images developed with an elemental parallax image one by one over √ (√/2) (=4) times for √ (√/2) (=4) groups, display is performed at a fixed ratio for the subsequent 32 elemental images, and replacement is performed by an adjacent parallax image for the next 32 elemental images. That is, by only obtaining a parallax image number developed within each elemental image based upon the way of thinking herein shown, smooth parallax image number switching can be realized like the case shown in FIG. 12.

As described above, by re-assigning a parallax image numbers developed according to the above policy from parallax image number developed within each elemental image and obtained from the equation (2) to develop them without obtaining the equation (3), (4), or (5), switching to a two-dimensional image display reflecting the defocus condition corresponding to FIG. 9 or FIG. 11 can be performed. For simplification, such a condition that √X or √ (√/2) becomes integer has been shown herein, but a case that √X or √(X/2) does not become integer can also be applied with a mathematically similar processing. That is, the degree of defocus at a switching time to a two-dimensional image display can be changed arbitrarily.

In the above, mixing of images with different parallax image numbers for each elemental image display region has been explained. However, when a resolution in a three-dimensional image display device is low, more specifically, a width of an elemental image or a lens width is large, such a fact that images with different parallax numbers have been mixed for each elemental image appears visually as separation of the images, which may be recognized as noises. Therefore, in some cases, it is necessary to perform mixing at a parallax image level. Accordingly, a method for switching parallax image numbers continuously performed by mixing a plurality of parallax image numbers within a parallax image within an elemental image for each pixel to develop them will be explained below.

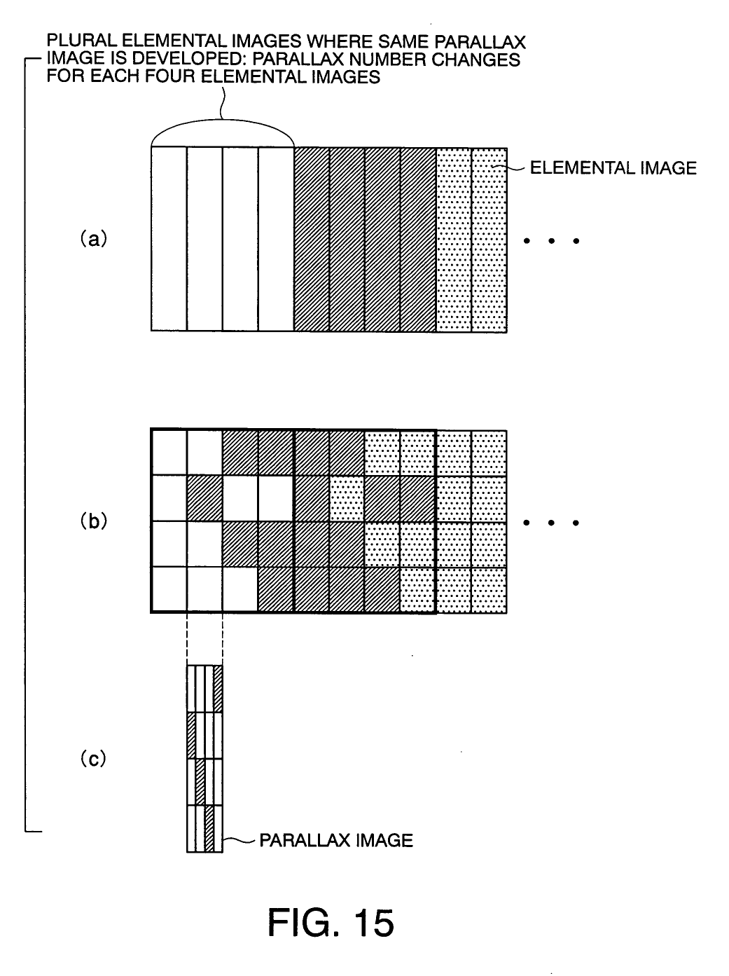

FIGS. 15(a), 15(b), and FIG. 15(c) are diagrams in a one-dimensional II system like the above. FIG. 15(a) is an illustrative diagram showing an example where the number of elemental images developed and displayed with the same parallax image from the result obtained from the equation (2) is 4 for simplification. Each elemental image is constituted of a plurality of parallax images (four in FIG. 15(c)), and a region viewed through an exit pupil is a region where an approximately singular parallax image at a three-dimensional image display time has been displayed. When the number of elemental images adopting the same parallax image number is represented as Y, change of a parallax number developed within an elemental image can be performed smoothly so as to correspond to FIG. 10(a) or 10(b) by increasing a ratio of mixing an adjacent image into a parallax image to be developed for each elemental image by 1/Y (=¼) of a pixel constituting a parallax image, as shown in FIG. 15(b). That is, as shown in FIG. 15(c), by mixing a plurality of parallax images to all four parallax image display regions constituting each elemental images, a ratio of a plurality of parallax images viewed via an exit pupil can be fixed. How to perform distribution for mixing two or more parallax images within a single parallax image display region can be performed by arranging the parallax images as uniform as possible utilizing an approach such as an area gradation studied for a liquid crystal display or the like, and such a way is not newly proposed in this text. Since an elemental image is constituted of a plurality of parallax image display regions, it is necessary to maintain only a ratio regarding how to perform distribution of different parallax image numbers in each region. Specifically, by arranging parallax images which are derived from a plurality of parallax image numbers with phases shifted between adjacent pixel columns in a state that only an occupying ratio of the parallax images is maintained, parallax images which are derived from a plurality of parallax image numbers viewed via exit pupils can be blended more uniformly considering that a numerical aperture of an exit pupil is finite.

When this method is employed, since different parallax images which are derived from different camera positions appear to separate from one another, whether or not such separations are recognized as noises depends on an original resolution in a two-dimensional image display unit. However, in order to realize a practical image quality in an actual three-dimensional image display device, a two-dimensional image display unit must have a sufficiently high resolution, so that it may be said that a viewer does not recognize the separations as noises. This method is a work for selecting parallax images for two-dimensional image display from a plurality of parallax images used at a three-dimensional image display time and develop them, and it is based upon assumption that one parallax image is constituted of a plurality of pixels. That is, in such a three-dimensional image display device where one parallax image is constituted of one pixel (for example, a two-dimensional II system where a focus of lens is directed to converging within one pixel), it is necessary to produce new one image data element set blended at a ratio for obtaining a plurality of parallax imaged in order to mix information elements for a plurality of parallax images within one parallax (=a single pixel). This is equivalent to producing an interpolating image between parallax images, and a technique therefor can be realized using an existing proposed technique such as a linear interpolation or a block matching. A technique of displaying a two-dimensional image viewed from an arbitrary position using such an interpolating image between parallax images is, of course, applicable to a case that a parallax image is constituted of a plurality of pixels, which has been explained above. However, for displaying a two-dimensional image using a three-dimensional image display device, the present invention specifically propose an approach for first obtaining main parallax image numbers to be developed within an elemental image by assuming a viewing point when switching display to a two-dimensional image is performed by only replacement of data used for a three-dimensional image especially in the II system, or the multiview system described latter and second mixing images so as to approximate to the state shown in FIG. 10(a) and 10(b), FIG. 12, or FIGS. 15(a), 15(b) and 15(c) in order to perform smooth parallax image number switching. (It is not necessary to produce a new image interpolation.)

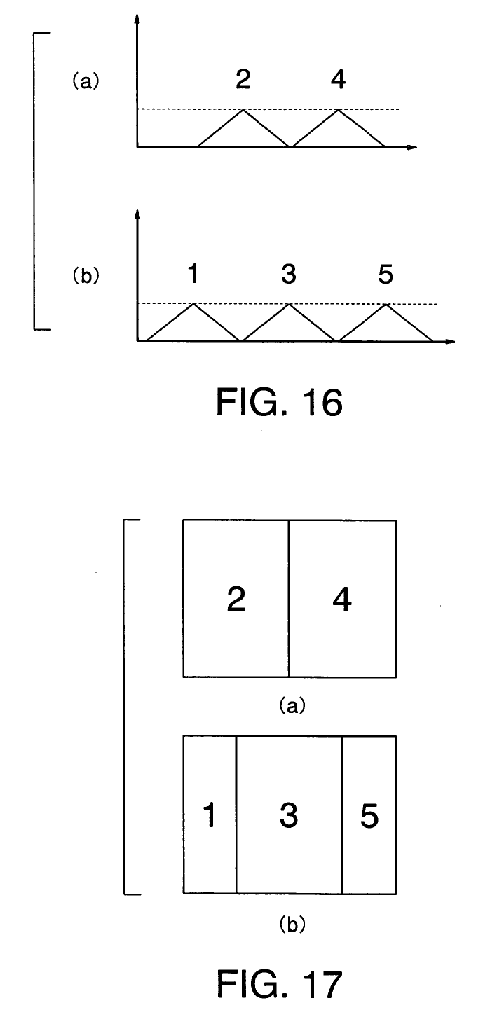

The method for realizing a continuous parallax number switching in an area gradation manner has been explained heretofore. Next, a method for realizing a continuous parallax number switching in a time-divisional manner (a time-divisional display) will be explained. For example, the image shown in FIG. 10(a) can be divided into constitutions shown in FIG. 16(a) and FIG. 16(b), focusing attention on an area which does not include overlapping. Therefore, images shown in FIG. 17(a) and 17(b) having constitutions shown in FIG. 16(a) and 16(b) may be outputted in a time-divisional manner.

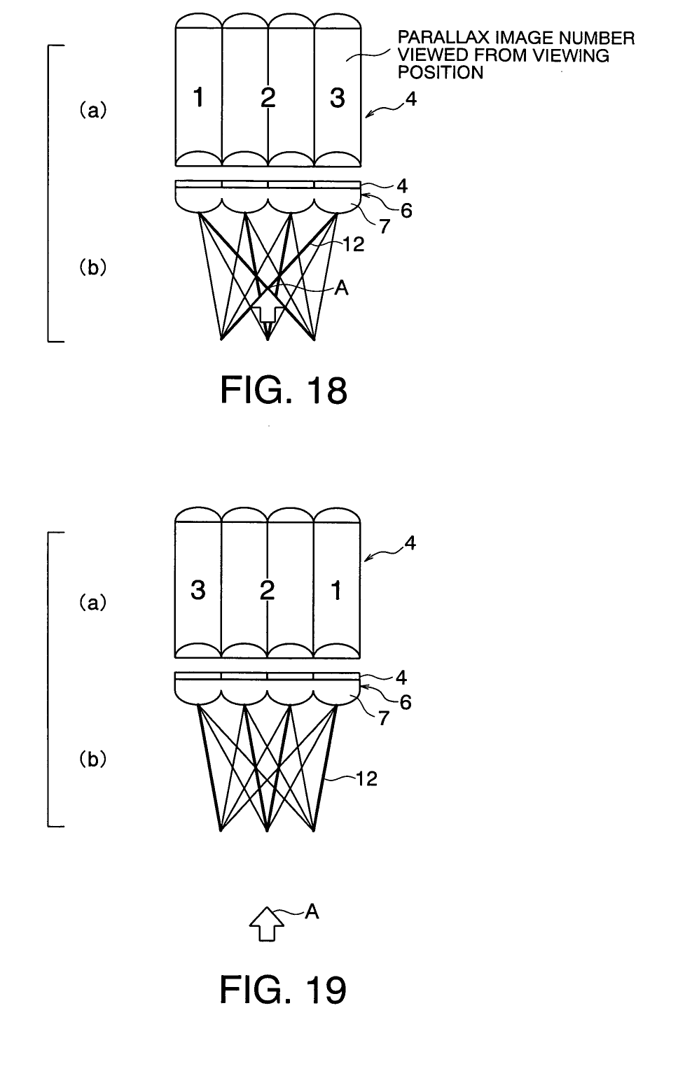

In the above, the switching display of two-dimensional image display in the II system has been explained. However, in a multiview system which allows a switching display to a two-dimensional image from a single perspective projection camera image, when it is intended to display a two-dimensional image acquired from a viewing point deviated from a viewing distance, it becomes necessary to sum images acquired from a plurality of cameras. An illustrative diagram of the concept are shown in FIG. 18(a) to FIG. 19(b). Incidentally, FIGS. 18(a) and 18(b) are diagrams showing a case that a viewing point is shorter than a viewing distance, FIG. 18(a) being a diagram showing a display plane of an image display unit 4 and FIG. 18(b) being a horizontal sectional view of a thee-dimensional image display device showing a relationship between a viewing point A and exit pupils 7. FIGS. 19(a) and 19(b) are diagram showing a case that a viewing point is longer than a viewing distance, FIG. 19(a) being a diagram a display plane of an image display unit 4 and FIG. 19(b) being a horizontal sectional view of a thee-dimensional image display device showing a relationship between a viewing point A and exit pupils 7. In both the cases of the case that the viewing point is shorter than the viewing distance (FIGS. 18(a) and 18(b)) and the case that the viewing point is longer than the viewing distance (FIGS. 19(a) and 19(b)), it is necessary to sum parallax images and parallax numbers to be selected are obtained form the viewing point A (image information is developed that is positioned at a crossing point of a line 12 connecting the viewing point A and the exit pupil 7 and the two-dimensional image display unit 4). A specific equation is not shown here, but switching to two-dimensional image display viewed from the viewing point A, i.e., the operation explained regarding the above II system can be applied by determining the viewing point A and developing a position where the line 12 connecting the viewing point A and the exit pupil 7 crosses the two-dimensional image display plane of the display unit 4 and parallax images displayed around the line 2 within an elemental image to which a parallax image belongs. Both mixing for each elemental image within the display plane and mixing for each pixel within the parallax image explained regarding the II system are applicable.

As described above, by mixing a parallax image adjacent area-wisely or time-wisely at a parallax number switching portion, discontinuity could be prevented from occurring at the parallax number switching portion. Since a two-dimensional image displayed by this method has reduced parallax about contents near a display plane, there is not a large difference in image between adjacent cameras, and influence to image quality due to mixing display is reduced, but a parallax becomes large regarding contents with much depth/projection amount, namely, image information elements which have low correlation with each other are mixed, which results in an defocused image. However, it can be understood that the blur is equivalent in quality to defocus appearing during displaying as a three-dimensional image (since parallax numbers viewed via an exit pupil appear in an area-wisely mixed manner, contents with much depth/projection amount will blur but realize continuous parallax number switching). That is, an image viewed in a defocused manner at a three-dimensional image display time is also displayed as a two-dimensional image in a blurred manner, but a image clearly displayed at a three-dimensional image display time is clearly displayed at a two-dimensional image display time, too.

Finally, an interface will be explained. As described above, as parameters at a switching time to a two-dimensional image, there are parameter (i) a position of a viewing point (perspective projection two-dimensional image acquiring position) about a position within the viewing zone from which a two-dimensional image to be switched should be viewed and parameter (ii) the degree of defocus about a ratio of an adjacent parallax image or the next adjacent parallax image to be mixed. As to the parameter (i), such an interface is desirable that the center of the viewing zone in the viewing distance is set to default and the position of the viewing point is changed according to an external input. As to the parameter (ii), since it is ideal that the same image quality as that on a three-dimensional image can be obtained at a two-dimensional display, a default should be reflected with design for an optical plate (which is the degree of defocus when the optical plate is a lens and which is a viewable range from a viewing point when the optical plate is a slit). Such an application as switching linked with an image can be adopted. That is, it is considered that a parallax image to be developed is obtained according to the equation (1) and the degree of defocus is determined from a displacement amount (for example, a voltage difference between pixel signals) of image information at a parallax image switching portion. Of course, switching may be conducted according to an external input. As there are various display modes in the current television, it is made possible to select image quality according to switching to a two-dimensional image display even in a three-dimensional image display device.

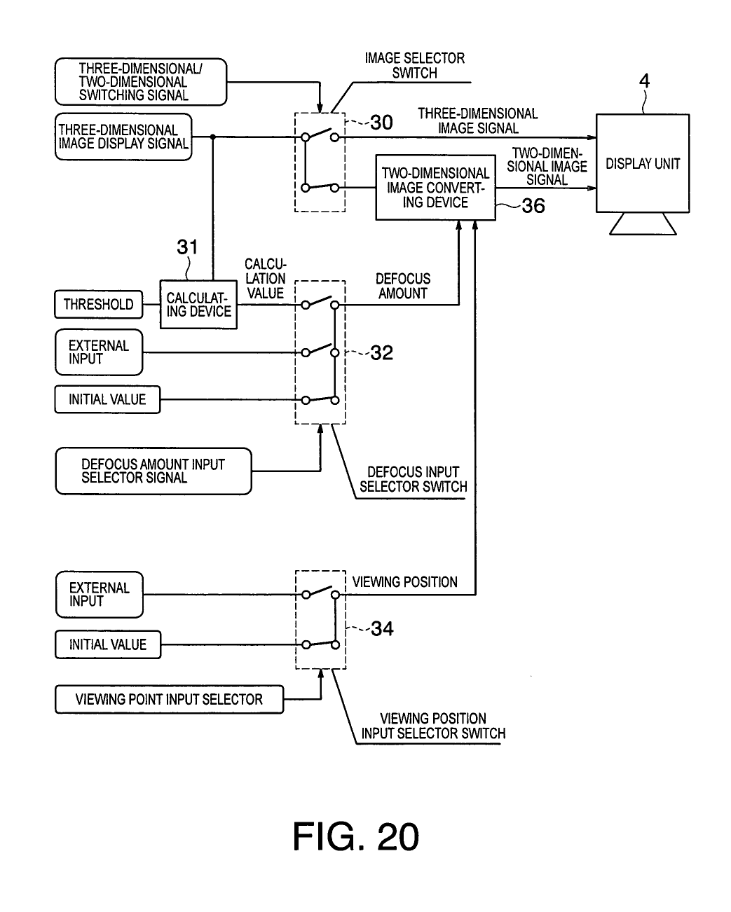

FIG. 20 is a block diagram showing a three-dimensional image display device according to an embodiment of the present invention. The three-dimensional image display device is provided with an image selector switch 30 for selecting an image to be displayed on an image display unit 4 for displaying an image, a defocus input selector switch 32, a viewing position input selector switch 34, and a two-dimensional image converting device 36 for converting a three-dimensional image signal to a two-dimensional image signal.

The image selector switch 30 is a switch for performing switching between a two-dimensional image and a three-dimensional image according to a three-dimensional/two-dimensional selector signal inputted from such an input device as a mouse or a keyboard, or produced by a switching element or the like. The three-dimensional/two-dimensional selector signal is required for only switching of High/Low, for example, such a setting is conducted that High corresponds to a three-dimensional image and Low corresponds to a two-dimensional image. Of course, setting of High and Law may be conducted in a reversed manner. Further, a switching timing is not required to be synchronized with a vertical synchronization signal and it may be asynchronous therewith.

The defocus input selector switch 32 selects either one of a calculation value calculated by a calculating device 31, an external input or an initial value based upon a defocus input selector signal to transmit the selected one to the two-dimensional image converting device 36.

The viewing position input selector switch 34 selects either one of an external input and an initial value as a viewing position based upon a viewing position input selector signal to transmit the selected one to the two-dimensional image converting device 36.

The two-dimensional image converting device 36 is a device for converting a transmitted three-dimensional image signal to a two-dimensional image utilizing the viewing position and the defocus amount as parameters. A converting method will be explained separately in detail. The viewing position and the defocus amount are set to initial values in shipping stage. A sufficiently excellent two-dimensional display can be achieved even utilizing the initial setting, but external inputting may be conducted according to an viewer's preference.

A method for inputting the viewing position externally can be performed according to a viewer's operation of an input device which is connected to the three-dimensional image display device in advance and which can detect a movement direction such as a mouse or a joystick and interlocking movement with the viewer's operation. Since a gyro element or the like can detect a movement direction, too, an input device with a gyro element is newly manufactured and it may be connected to the three-dimensional image display device in advance. Switching constitution between the initial value and the external input may be embedded into a software such that a selector switch for an initial value fixed mode and an external input mode is provided on a screen of the image display device, and it may be constituted of hard mechanism such as a slide switch.

When a defocus amount is inputted externally, only means for inputting a defocus amount directly such as a keyboard may be provided. However, since it is difficult to predict a proper defocus amount from a display image, it is difficult to obtain an excellent display image. Therefore, it is desirable to further provide a constitution for automatically calculating a defocus amount from a display image and utilizing the calculation result as a reference value to allow increase/decrease of any value to the reference value. In the calculating device, a luminance difference between adjacent pixels at a parallax image number switching portion is calculated and the calculation result is outputted such that the difference reaches a level (threshold) at which a viewer does not feel uncomfortable or less. It is made possible to display contents with a large depth/projection amount without uncomfortable feeling by this operation.

As described above, a two-dimensional image acquired from an arbitrary viewing point within a viewing zone can be switching-displayed by selecting one of a three-dimensional image display image to develop and display the same. Such a display is interlocked with an external input such as a mouse operated by a viewer, so that an interface which serves so as to change a viewing point in a state that a two-dimensional image has been displayed, change a viewing distance, or further control the degree of blur can be realized.

A case that a three-dimensional image displayed in a three-dimensional image display device is outputted as a two-dimensional output, for example, a printed matter. In that case, since the two-dimensional image is printed at a resolution of the three-dimensional image, the case that a two-dimensional image is displayed on a three-dimensional image display device has been described heretofore, but a process for developing a parallax image defined in this proposal in each elemental image is omitted. That is, defining an exit pupil in a three-dimensional image display device as a pixel, image information to be displayed on each pixel (print dot) according to the equation (2) and a mathematical handling, or a distribution defined according to the equations (3) to (5), and a course of developing the same image a plurality of pixels for an elemental image viewed via an exit pupil when switching display to a two-dimensional image is performed in the three-dimensional image display device is specific to three-dimensional display. As regard printed matter, two parallax image distributing methods based upon an elemental image unit and a pixel unit are considered, but the latter method is further desirable. That is, mixing parallax image for each print dot rather than mixing parallax image for each print dot group can realize further fine parallax image number switching.

Finally, only the II system which parallel beams are emitted from exit pupils adjacent to each other has been explained heretofore, but the present invention is effective for all an II system where a converging point of light beams does not occur at a viewing position and a multiview system, of course.

### EXAMPLE 1

In the example, only parallax effective for stereoscopic view is applied. QUXGA−LCD (the number of pixels=3200×2400, screen size=422. 4 mm×316.8 mm) was used as a liquid crystal display element. The minimum driving unit is each sub-pixel of R, G, and B, and one pixel (a triplet) is formed of 3 sub-pixels of R, G, and B generally arranged horizontally. In a display unit of the example, however, a parallax image was arranged for each sub-pixel of R, G, and b in order to increase a horizontal resolution. A horizontal width of a sub-pixel is 44 μm and a vertical length thereof is 132 μm. A back light was arranged behind the display unit and a lenticular sheet having cylindrical lenses with a width of 0.704 mm arranged on a side of a viewer for applying parallax information only in a horizontal direction according to an II system was combined therewith. Regarding each parameter of the lens, a defocus region is set to about a sub-pixel width by positioning a pixel face of the liquid crystal display element slightly inwardly from a focal length, and a lens made from polycarbonate was determined so as to have a radius of about 1.0 mm and a lens thickness of 1.2 mm.

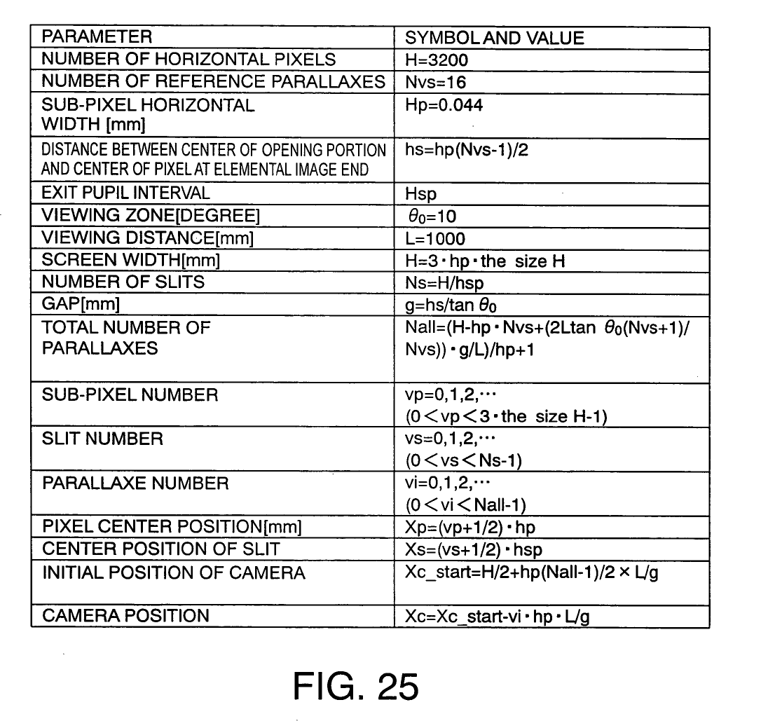

Here, respective parameters have values shown in FIG. 25.

A three-dimensional image display image was produced according to FIG. 25. The total number of parallaxes was 34 parallaxes, parallax numbers N (Xp, Xs) constituting an elemental image arranged in the vicinity of the center facing the center of a viewing zone within the display unit was 8 to 23. On the other hand, N (Xp, Xs)=0 to 15 were allocated to an elemental image corresponding to the second slit 4 from the left end of the screen, and N (Xp, Xs)=18 to 33 were allocated to an elemental image corresponding to the second slit 4 from the right end thereof, and the position of each elemental image was shifted from a corresponding slit outwardly. That is, a parallax image having a whole screen information was not present.

When switching to a two-dimensional image display viewed from the center position in the viewing distance defined by a default value was performed, an elemental image number developed according to the equation (2) switched at an approximately intermediate position of a generation position (for each 32 to 33 elemental images) of an elemental image constituted of 17 parallaxes (=(the reference number of parallaxes+1) parallaxes; discrete occurrence for realizing an elemental image width>a pitch of exit pupils in a pseudo manner at a three-dimensional image display time. Further, since a defined value reflecting design of a lens (defocus) was one pixel, a continuous switching approximating to the relationship shown in FIGS. 10(a) and 10(b) was performed. Mixing of different parallax image numbers was mixing-distributed for each pixel in a range of one sub-pixel in a horizontal direction and 240 sub-pixels in a longitudinal direction which is a parallax image display region.

Thereby, a two-dimensional image display equivalent to a case that a three-dimensional image was viewed from the center of the viewing zone in the viewing distance with one eye of a viewer when the three-dimensional image was displayed was realized.

As described above, switching to a two-dimensional image viewed from the center at the viewing distance was realized by only re-arrangement of pixel information about three-dimensional image display.

### EXAMPLE 2

In addition to example 1, by employing such a constitution that the viewing point could be moved arbitrarily within a viewing zone according to movement of a mouse, such a display that an object was rotated within a two-dimensional image in an interlocking manner with the mouse could be realized. In detail, a moving direction of the mouse and a moving direction of the viewing point were set within a screen in a reversed direction regarding a horizontal vector. Further, a three-dimensional image viewed from a preferential direction for a viewer was outputted for print with a resolution of the three-dimensional image as a two-dimensional image which could be viewed from an arbitrary position within the viewing zone by using a parallax image for development in each elemental image selected in the example as it was.

### EXAMPLE 3

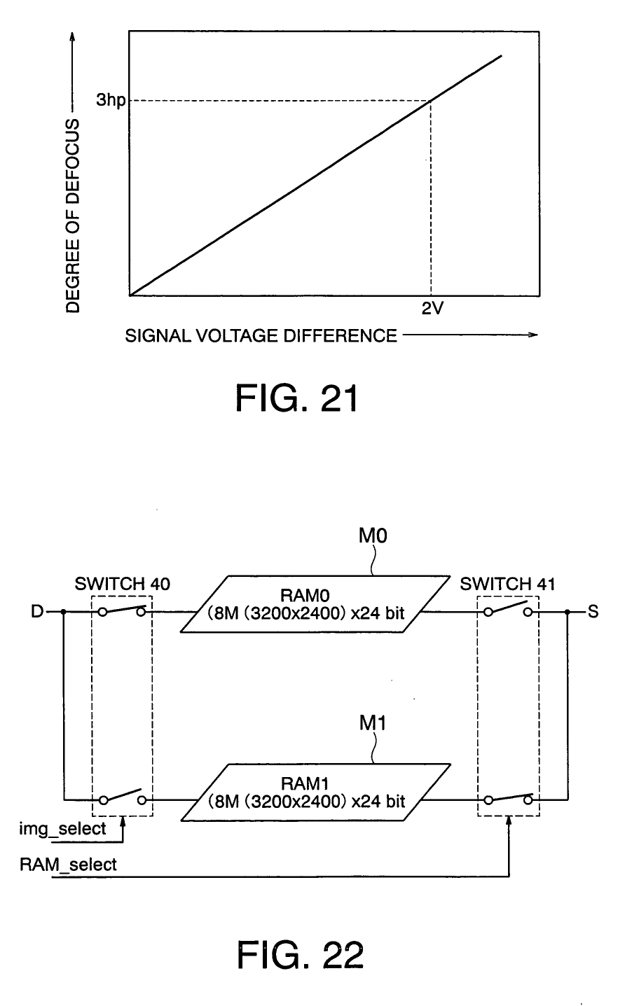

In addition to example 1, when parallax image numbers were arranged according to the equation (2), such a constitution was employed that a signal voltage difference at a parallax image number switching boundary was detected and the degree of defocus was changed according to the magnitude of the difference (FIG. 21). As a result, such a display that focus was obtained on a screen regarding contents with a large projection/depth amount and natural focus was obtained in addition thereto was obtained, and a clear display was obtained as a whole regarding contents with a small projection/depth amount. The signal voltage difference reflected the degree of discontinuity at a seam between parallax images, and there was such a tendency that an amount of defocus was set to be smaller regarding contents with a small projection/depth amount while an amount of defocus was set to be larger regarding contents with a large projection/depth amount.

### EXAMPLE 4

In the example, continuous switching of parallax images was realized according to a time-divisional display in a constitution similar to that in example 1.

A specific constitution is shown in FIG. 22. An image signal D was constituted of a bus width of a total 24 bits of 8 bits for a R (red) gradation signal, 8 bits for a G (green) gradation signal, and 8 bits for a B (blue) gradation signal. A switch 40 was inputted with “image−select” signal for identifying contents of an image signal, and the image signal D was allocated to a memory M0 constituted of a RAM 0 or a memory M1 constituted of a RAM 1 according to the signal to be reserved. For example, an image shown in FIG. 17(a) was reserved in the memory M0, an image shown in FIG. 17(b) was reserved in the memory M1, and time-divisional display was realized by outputting the image reserved in the memory M0 and the imaged reserved in the memory M1 through a switch 41 in a switching manner.

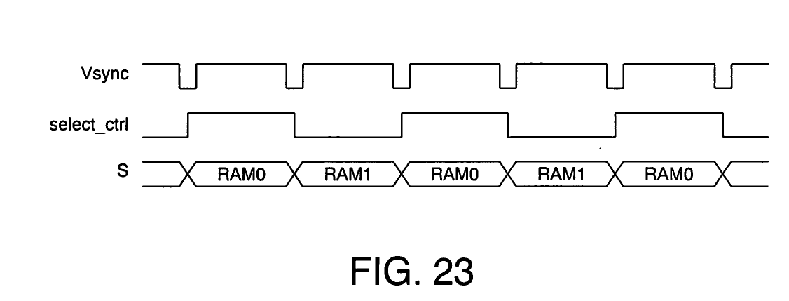

An operation of the switch 1 will be explained. The switch 1 was inputted with a control signal (select−ctrl) for determining a ratio of an output period of the memory M0 and an output period of the memory M1 to each other. First of all, when the time-divisional display was implemented simply, as shown in FIG. 23, a duty ratio of the control signal “select−ctrl” was set to 50%. The control signal “select−ctrl” can be produced easily from a logic circuit such as a flip-flop.

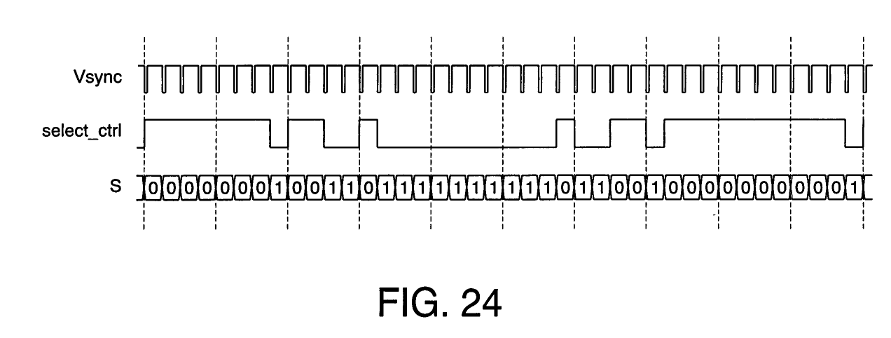

In order to perform output at a more correct relationship of √X×√X, an output ratio of the memory M0 and the memory M1 was fluctuated in a time-divisional manner. For example, the output ratio of the memory M0: the memory M1 at X=16 was set to 4:0. 3:1, 2:2, 1:3, 0:4, 1:3, 2:2, and 3:1. FIG. 24 shows one example at X=16. The control signal “select−ctrl” herein can be produced easily from a logic circuit such as flip-flop.

In the example, such a constitution was employed that High or Low was continuously outputted at the output ratio of 3:1 or 2:2. However such a divisional constitution may be employed that High is outputted two times, Low is outputted one time, and High is outputted one time at an output time with the output ratio of 3:1. Such an output constitution can be implemented by only changing an output pattern of the control signal (select−ctrl).

### COMPARATIVE EXAMPLE

When only an image with a parallax image number 17 was developed under the conditions in example 1, a region at the right side of a screen was not displayed and distortion was further included due to that an image acquired by an orthographic projection method.

As explained above, according to the present invention, a two-dimensional image which is not discontinuous and does not have distortion can be obtained from three-dimensional image display data rapidly.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

1. A three-dimensional image display device comprising:
a display unit obtained by arranging pixels constituting a pixel group displaying an elemental image in a matrix array; and
an optical plate including exit pupils associated with the pixel group,
the elemental image being constituted from a collection of image data which is constituent elements for parallax images acquired from a plurality of directions and regions where the parallax images acquired from the plurality of directions can be viewed being approximately separated from one another spatially to display a three-dimensional image, wherein
when switching display to a two-dimensional image is performed using the image data elements for displaying a three-dimensional image, a viewing point within a viewing zone is set, and image data which is constituent elements for a parallax image displayed on pixels positioned at a position where a line connecting the viewing point and an exit pupil, and the display unit cross each other or positioned in the vicinity thereof in a state that a three-dimensional image is displayed is developed and displayed within a corresponding elemental image including the pixels.

2. A three-dimensional image display device according to claim 1, wherein the image data which is constituent elements for a parallax image displayed on pixels positioned at a position where a line connecting the viewing point for a three-dimensional image display and the exit pupil, and the display unit cross each other or positioned in the vicinity thereof in a state that an image for displaying a three-dimensional image is displayed is developed within the corresponding elemental image, while maintaining a ratio where the image data which is the constituent elements for each parallax image spatially occupies the position or the vicinity of the position, so that switching to a two-dimensional image is performed.

3. A three-dimensional image display device according to claim 2, wherein, when the ratio where the image data which is the constituent elements for each parallax image spatially occupies the position or the vicinity of the position, a range about the position where a line connecting the viewing point and the exit pupil, and the display unit cross each other is made variable, and a size of the range can be changed according to external input.

4. A three-dimensional image display device according to claim 2, wherein, when the ratio where the image data which is the constituent elements for each parallax image spatially occupies the position or the vicinity of the position, a range about the position where a line connecting the viewing point and the exit pupil, and the display unit cross each other is made variable, and a mechanism configured to change the range automatically according to magnitude of a displacement amount of an image between the elemental images is provided.

5. A three-dimensional image display device according to claim 2, wherein, when development is performed within the corresponding elemental image so as to maintain the ratio where the image data which is the constituent elements for each parallax image spatially occupies the position or the vicinity of the position, time-wise mixing is performed.

6. A three-dimensional image display device according to claim 1, wherein the image data which is constituent elements for a parallax image displayed in a range equal to a horizontal direction pitch or a vertical direction pitch for arranging image data which are constituent elements for a different parallax image is developed within the corresponding elemental image about the position where a line connecting the viewing point and the exit pupil, and the display unit cross each other in a state that an image for displaying a three-dimensional image is displayed, while maintaining a ratio where the image data which is the constituent elements for each parallax image spatially occupies the range, so that switching to a two-dimensional image is performed.

7. A three-dimensional image display device according to claim 6, wherein, when the ratio where the image data which is the constituent elements for each parallax image spatially occupies the position or the vicinity of the position, a range about the position where a line connecting the viewing point and the exit pupil, and the display unit cross each other is made variable, and a size of the range can be changed according to external input.

8. A three-dimensional image display device according to claim 6, wherein, when the ratio where the image data which is the constituent elements for each parallax image spatially occupies the position or the vicinity of the position, a range about the position where a line connecting the viewing point and the exit pupil, and the display unit cross each other is made variable, and a mechanism configured to change the range automatically according to magnitude of a displacement amount of an image between the elemental images is provided.

9. A three-dimensional image display device according to claim 6, wherein, when development is performed within the corresponding elemental image so as to maintain the ratio where the image data which is the constituent elements for each parallax image spatially occupies the position or the vicinity of the position, time-wise mixing is performed.

10. A three-dimensional image display device according to claim 1, wherein the image data which is constituent elements for a parallax image displayed in a range equal to two times a horizontal direction pitch or a vertical direction pitch for arranging image data which are constituent elements for a different parallax image is developed within the corresponding elemental image about the position where a line connecting the viewing point and the exit pupil, and the display unit cross each other in a state that an image for displaying a three-dimensional image is displayed, while maintaining a ratio where the image data which is the constituent elements for each parallax image spatially occupies the range, so that switching to a two-dimensional image is performed.

11. A three-dimensional image display device according to claim 10, wherein, when the ratio where the image data which is the constituent elements for each parallax image spatially occupies the position or the vicinity of the position, a range about the position where a line connecting the viewing point and the exit pupil, and the display unit cross each other is made variable, and a size of the range can be changed according to external input.

12. A three-dimensional image display device according to claim 10, wherein, when the ratio where the image data which is the constituent elements for each parallax image spatially occupies the position or the vicinity of the position, a range about the position where a line connecting the viewing point and the exit pupil, and the display unit cross each other is made variable, and a mechanism configured to change the range automatically according to magnitude of a displacement amount of an image between the elemental images is provided.

13. A three-dimensional image display device according to claim 10, wherein, when development is performed within the corresponding elemental image so as to maintain the ratio where the image data which is the constituent elements for each parallax image spatially occupies the position or the vicinity of the position, time-wise mixing is performed.
